(19) United States
(12) Patent Application Publication
(10) Pub. No.: US 2025/0141041 A1
(43) Pub. Date: May 1, 2025

(54) MULTI-LAYERED CAP SHINGLE WITH ENHANCED WIND PERFORMANCE AND METHOD OF MAKING SAME

(71) Applicant: BMIC LLC, Dallas, TX (US)

(72) Inventors: Luis Duque, Hackensack, NJ (US); Ming-Liang Shiao, Basking Ridge, NJ (US); Sudhir Railkar, Wayne, NJ (US)

(21) Appl. No.: 18/949,215

(22) Filed: Nov. 15, 2024

Related U.S. Application Data
(63) Continuation of application No. 18/225,338, filed on Jul. 24, 2023, now Pat. No. 12,180,710.
Application No. 18/225,338 is a continuation of application No. 17/554,053, filed on Dec. 17, 2021, now Pat. No. 11,753,826.
Application No. 17/554,053 is a continuation of application No. 16/915,005, filed on Jun. 29, 2020, now Pat. No. 11,203,871.
Application No. 16/915,005 is a continuation of application No. 15/617,183, filed on Jun. 8, 2017, now Pat. No. 10,787,814.
(60) Provisional application No. 62/368,058, filed on Jul. 28, 2016.

(51) Int. Cl. H01M 50/42; C08F 220/56; C08K 3/22; H01M 50/423; H01M 50/446

(52) U.S. Cl. CPC H01M 50/42; C08F 220/56; C08K 3/22; H01M 50/423; H01M 50/446; C08F 2800/20; C08K 2003/2227

(57) ABSTRACT

A multi-layer cap shingle for installation along a ridge, hip, or rake of a roof includes a forward exposure area and a rear headlap area, and at least two layers of shingle material bonded together with patches of lamination adhesive adjacent their opposed edges. The bottom layer is configured with a deformation-absorbing mechanism such as a pair of slots extending from a forward edge rearwardly. When the multi-layer cap shingle is bent over a roof ridge, the slots of the bottom layer of shingle material narrow in width so that the bottom layer bends around an arc of slightly smaller radius than the top layer of shingle material. As a result, the opposed edges of the bottom and top layers remain aligned, and the edges of the top layer are laminated to the bottom layer to increase wind lift resistance of the installed multi-layer cap shingle.

### REFERENCE TO RELATED APPLICATION

The present Patent Application is a continuation of previously filed, co-pending U.S. patent application Ser. No. 18/225,338, filed Jul. 24, 2023, which is a continuation of U.S. patent application Ser. No. 17/554,053, filed Dec. 17, 2021, now U.S. Pat. No. 11,753,826, issued on Sep. 12, 2023, which is a continuation of U.S. patent application Ser. No. 16/915,005, filed Jun. 29, 2020, now U.S. Pat. No. 11,203,871, issued on Dec. 21, 2021, which is a continuation of United States Patent Application No. 15/617, 183, filed Jun. 8, 2017, now U.S. Pat. No. 10,787,814, issued Sep. 29, 2020, which claims the benefit of U.S. Provisional Patent Application No. 62/368,058, filed Jul. 28, 2016.

### INCORPORATION BY REFERENCE

U.S. patent application Ser. No. 18/225,338, filed Jul. 24, 2023, United States patent application Ser. No. 17/554,053, filed Dec. 17, 2021, now U.S. Pat. No. 11,753,826, issued on Sep. 12, 2023, U.S. patent application Ser. No. 16/915,005, filed Jun. 29, 2020, now U.S. Pat. No. 11,203,871, issued on Dec. 21, 2021, U.S. patent application Ser. No. 15/617,183, filed on Jun. 8, 2017, now U.S. Pat. No. 10,787,814, issued on Sep. 29, 2020, and U.S. Provisional Patent Application No. 62/368,058, filed Jul. 28, 2016, are specifically incorporated by reference herein as if set forth in their entireties.

### TECHNICAL FIELD

This disclosure relates generally to architectural asphalt roofing shingles and more specifically to multi-layered cap shingles for covering a ridge, hip, or rake of a shingled roof to present a look of thickness and depth.

### BACKGROUND

Special cap shingles have long been used in asphalt roofing to cover or cap ridges, hips, and rakes of shingled roofs. When using simple three-tab shingles, the cap shingles often are cut from full shingles such that the individual tabs become the exposure areas of the cap shingles along a ridge or hip of a roof. In recent years, so-called architectural shingles have become highly desirable for residential roofing. Architectural shingles typically are formed of stacked layers of shingle material laminated together, shaped, and shaded to present a thicker and more textured look on a roof. For example, the well-known “dragon tooth” shingle design has a lower layer of shingle material with an upper layer bonded thereto to form a two layer shingle. The upper layer is cut to define irregular tabs known as dragon teeth. This, along with strategic shading with protective granules presents an aesthetically pleasing and desirable textured appearance on a roof.

With the growth in popularity of architectural shingles came a demand for cap shingles that complement the thick textured appearance of a roof covered with architectural shingles. Such cap shingles could no longer simply be cut from full singles as they had been with simple three-tab shingles. Accordingly, special purpose cap shingles have been developed for covering ridges, hips, and rakes of a roof. These cap shingles generally also are multi-layered in nature. Some are formed by folding portions of a blank onto other portions to form multiple layers and provide increased thickness. In other cases, architectural cap shingles are fabricated by laminating two or more layers of shingle material together to obtain thickness and the appearance of depth and texture along a ridge, hip, or rake of a roof.

One issue inherent in multi-layer cap shingles arises from the fact that they must be bent to be installed along a ridge, hip, or rake. Since the layers of such cap shingles lie in slightly different juxtaposed planes, their upper layers must bend around an arc with a slightly larger radius than the lower layers. As a result, the layers must be able to move with respect to one another as the cap shingle is bent to accommodate the different arcs around which they must extend. One solution to this requirement has been a multi-layered cap shingle with layers that are laminated together along only one side. This allows the upper and lower layers of the cap shingle to slide with respect to one another when the cap shingle is bent.

While this solution has been somewhat successful, it nevertheless has certain problems and shortcomings inherent in its construction. It has been discovered, for instance, that cap shingles laminated only on one side exhibit disappointing wind lift resistance on the side where the layers are not laminated together. Furthermore, since the layers of the cap shingle slide relative to one another when the shingle is bent, the edges of the shingle on the un-laminated side often become misaligned when the cap shingles are installed. More specifically, the layers of ridge cap shingles bent to accommodate a steeper sloped roof slide more relative to one another when bent than do ridge cap shingles bent to accommodate a less steeply sloped roof. Since it would not be feasible to fabricate cap shingles for all possible roof slopes, a compromise is struck and there is almost always a difference between the alignment of the layer edges on the un-laminated sides of installed cap shingles. Also, the layers on the un-laminated side do not always lay flat against one another. Some consider this unsightly.

A need exists for a multi-layered architectural cap shingle that exhibits superior wind lift resistance along both edges of the shingle. A related need exists for a multi-layered cap shingle that retains the same degree of alignment of the opposed edges of its layers along both edges of the shingle regardless of the angle through which the shingle must be bent to accommodate a particular roof pitch. A need also exists for a multi-layered cap shingle having layers that are flat against one another and flush when the shingle is installed. It is to the provision of a multi-layered cap shingle that addresses these and other needs that the present disclosure is primarily directed.

### SUMMARY

Briefly described, a multi-layered cap shingle comprises multiple layers of shingle material laminated together along both edges of the shingle, at least in the exposure area. Lower layers of the shingle have relief features in the form of deformation absorption mechanisms. The relief features allow these lower layers to narrow slightly as the shingle bends around an arc with the upper layers of the shingles bending around a slightly larger arc than the lower layers. This, in turn, lends flexibility to the multi-layer shingle allowing it to bend over a ridge or hip easily as if it had only one layer. Further, the layers remain aligned along both of the opposed edges of the shingle regardless of the slope of a roof being accommodated. Since laminating adhesive bonds the layers along both side edges of the shingle, at least in the exposure areas, the layers lay flat atop with one another. The upper layer cannot rise up away from the lower layer.

Perhaps most salient, however, is that wind lift resistance is very good along both of the exposed side edges of the multi-layer cap shingle. The deformation absorption mechanisms that allow the upper layer to bend around a slightly larger arc than the lower layer may comprise spaced longitudinal slots formed in the exposure areas of the lower layer. Alternatively, the lower layers may be completely discontinuous and the discontinuities may be spanned with strips that flex or that bunch together when the shingle is bent to absorb relative movement between the layers.

Accordingly, a multi-layer cap shingle is disclosed that has superior wind lift resistance on all sides, that does not exhibit misalignment of the layers along either of the opposed side edges of the layers of the shingle, that has layers that lay flat and flush on one another when the shingle is installed, and that exhibits superior wind resistance. These and other features, aspects, and advantages of the multi-layer cap shingle of this disclosure will be better appreciated upon review of the detailed description set forth below taken in conjunction with the accompanying drawing figures, which are briefly described as follows.

### BRIEF DESCRIPTION OF THE DRAWINGS

FIG. 1 is a perspective exploded view of a prior art multi-layer cap shingle showing the layers adhered on only one side.

FIG. 2 is an end view of the cap shingle of FIG. 1 with the shingle assembled for installation.

FIG. 3 shows the prior art cap shingle of FIGS. 1 and 2 installed along a ridge cap and illustrates problems and shortcomings of the prior art.

FIG. 4 is a perspective exploded view of a multi-layer cap shingle that embodies principles of the present disclosure in one preferred form.

FIG. 5 is a front edge view of the multi-layer cap shingle of FIG. 4 assembled for installation.

FIG. 6 is a front edge elevation of the multi-layer cap shingle of FIG. 5 as it appears when bent over a ridge of a roof.

FIGS. 7a-7d are plan views of the bottom layer of a multi-layer cap shingle according to the disclosure showing various embodiments of the relief features or deformation-absorbing mechanisms incorporated in the lower layer.

FIG. 8 is a perspective exploded view of a multi-layer cap shingle made up of three layers and showing incorporation of a deformation-absorbing mechanism in the bottom two layers.

FIG. 9 is a front edge elevation showing another embodiment of a multi-layer cap shingle according to the disclosure.

FIG. 10 is a front edge elevation showing another embodiment of a multi-layer cap shingle according to the disclosure.

FIG. 11 is a front edge elevation showing yet another embodiment of a multi-layer cap shingle according to the disclosure.

### DETAILED DESCRIPTION

Reference will now be made to the attached drawing figures, wherein like reference numerals indicate like parts throughout various ones of the views. FIGS. 1-3 illustrate a typical prior art multi-layer cap shingle. The prior art multi-layer cap shingle 11 includes a top layer of shingle material 12 and a bottom layer of shingle material 13 each having opposed side edges. The top and bottom layers 12 and 13 overlie one another and are laminated together along one of their respective edges by a laminating adhesive 14, which can be asphalt or any other appropriate adhesive.

The opposite edges of the top and bottom layers are not laminated together so that the layers of shingle material are free to slide with respect to one another except wherein they are laminated together. The prior art multi-layer cap shingle, which is generally rectangular in shape, has an exposure area 9 and a headlap area 10 (FIG. 1). When a plurality of multi-layer cap shingles are installed along a ridge, the exposure area of each multi-layer cap shingle overlies the headlap area of an adjacent one of the multi-layer cap shingles in “piggyback” fashion. Sealant patches 15 may be applied along a forward edge of the bottom layer of shingle material. These sealant patches adhere the multi-layer cap shingle to the underlying headlap area of an adjacent multi-layer cap shingle when the shingles are installed along a ridge, hip, or rake of a roof.

The prior art multi-layer cap shingle of FIGS. 1-3 is installed along a ridge of a roof by being bent around an arc to extend over the ridge. The arc is more extreme for higher pitched roofs such as a 12/12 pitch than for lower pitched roofs such as an 8/12 pitch. This bending is illustrated in FIG. 3. The top layer and the bottom layer each bend to span the roof ridge. However, the top layer must extend around an arc of slightly greater radius and slightly greater length than the bottom layer since the top layer is further from the axis of curvature. The purpose of the un-laminated edges of the top and bottom layers is to accommodate this difference by allowing the top layer to slide relative to the bottom layer as the shingle is bent. This is illustrated at 18 in FIG. 3, where the edge of the top layer 12 has become inwardly displaced from the edge of the bottom layer 13.

Relative sliding displacement of the top and bottom layers of the multi-layer cap shingle upon installation has long been a problem with prior art multi-layer cap shingles. The top and bottom layers of prior art multi-layer cap shingles are left un-laminated along one edge specifically to allow for relative sliding movement of the top and bottom layers as they are bent over a roof ridge. However, some designers and homeowners consider it unsightly for one edge (the laminated edge) of the cap shingles to have aligned layers when the opposite edge (the un-laminated edge) has layers that are misaligned along the edge. Furthermore, the fact that the layers are not laminated along one edge renders prior art multi-layer cap shingles less resistant to uplift as a result of wind from the direction of the un-laminated edges. The present disclosure, detailed below, addresses both of these problems.

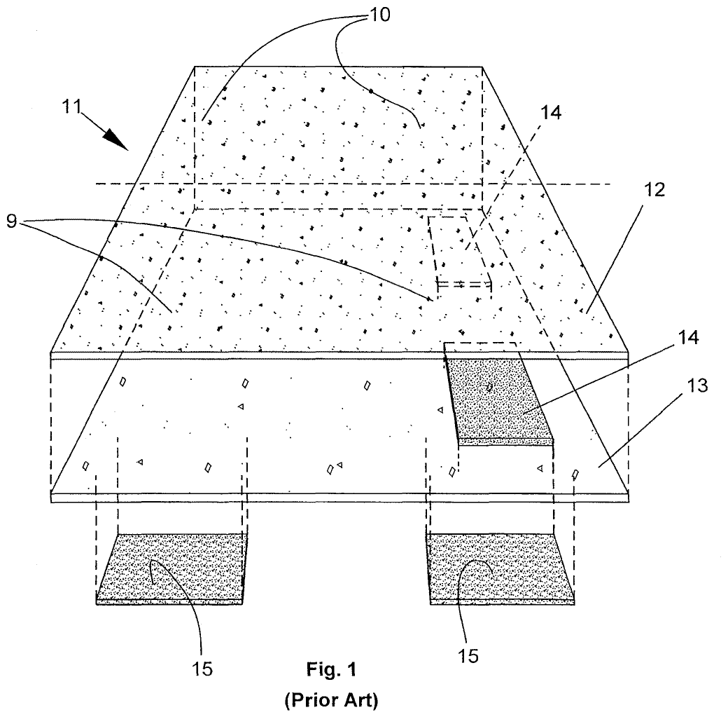

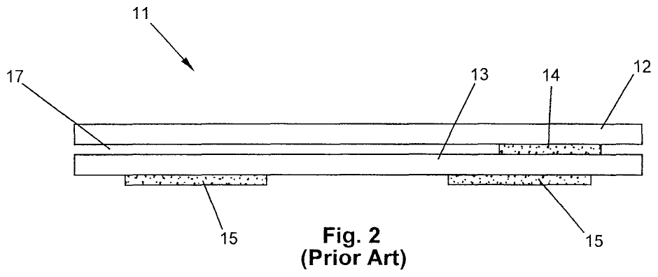

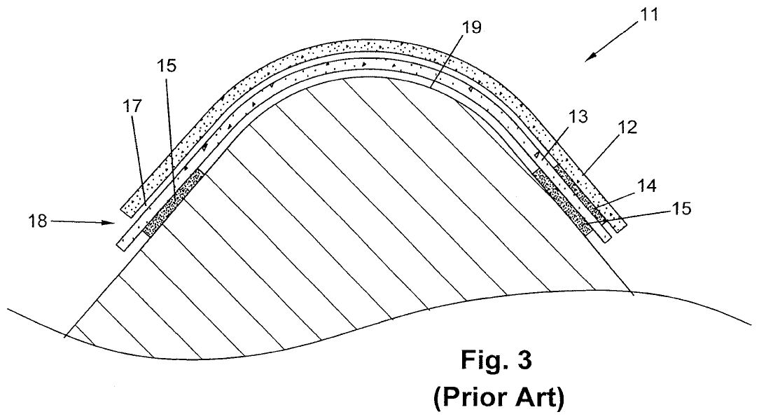

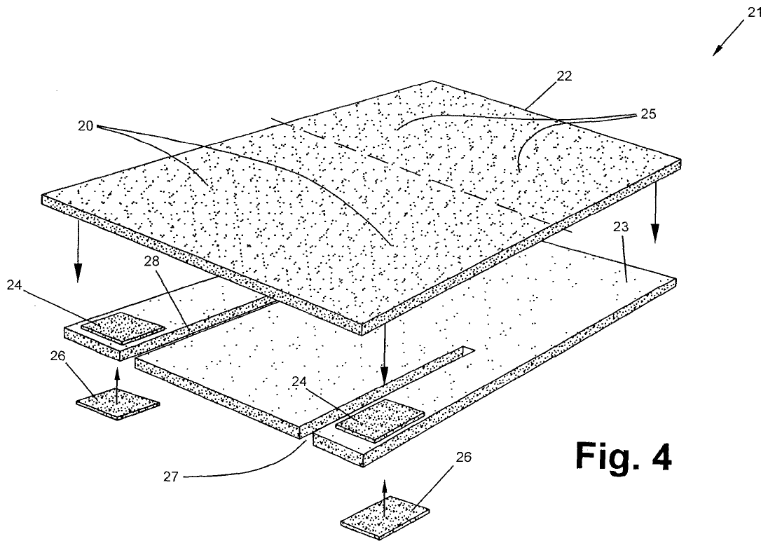

FIGS. 4-6 illustrate an improved multi-layer cap shingle that embodies principles of the present disclosure in one exemplary form. Referring first to FIG. 4, the multi-layer cap shingle 21 includes a top layer 22 of shingle material and a bottom layer 23 of shingle material. The shingle 21 has an exposure area 20 and a headlap area 25. As is traditional, the headlap area of the multi-layer cap shingle 21 will be overlapped by the exposure area of an adjacent multi-layer cap shingle in piggyback fashion when a plurality of shingles is installed along the ridge of a roof. The bottom and top layers are laminated together by means of laminating adhesive 24 positioned between the two layers. More specifically, a patch of laminating adhesive 24 is applied between the layers adjacent the two opposed edges at least in the exposure area 20 as shown. Sealant patches 26 may be applied to the lower surface of the bottom layer 23 to adhere the exposure area 20 to the underlying headlap area of an adjacent multi-layer cap shingle in an installation of shingles along a ridge.

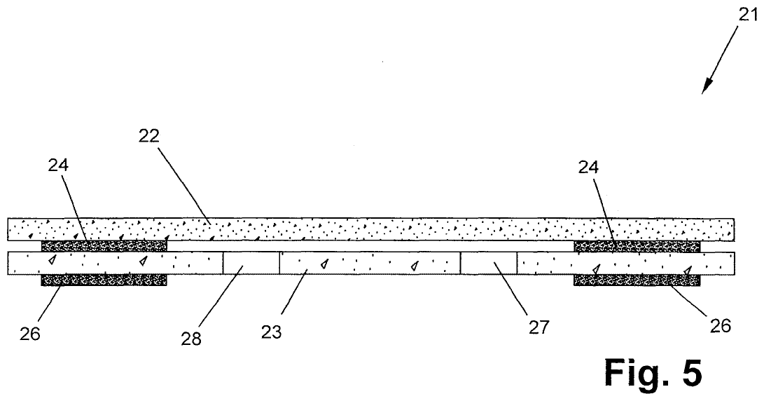

The bottom layer 23 of the multi-layer cap shingle 21 includes a relief feature or deformation-absorbing mechanism located between the two patches of laminating adhesive 24. In the embodiment of FIG. 4, the deformation-absorbing mechanism is configured as two slots 27 and 28 that extend from the forward edge of the bottom layer of shingle material rearwardly toward the headlap area 25. In this embodiment, there is no laminating adhesive in the region between the two slots. FIG. 5 is a forward edge plan view of the embodiment of FIG. 4 illustrating the top layer 22, the bottom layer 23, laminating adhesive patches 24, and sealant patches 26. The open ends of the slots 27 can be seen. It should be noted that in FIG. 5 and most of the drawing figures, the thicknesses and spacing of components are exaggerated for clarity. In reality, the top and bottom layers are closely juxtaposed and the shingle material, laminating adhesive, and sealant patches are thinner than depicted.

FIG. 6 shows the multi-layer cap shingle 21 being bent around an arc as illustrated by arrows 32 in the manner in which it is bent when installed along the ridge of a roof. As with the prior art described above, the top layer must bend around an arc of slightly larger radius and slightly longer length than the bottom layer. Said another way, the bottom layer must bend around an arc of slightly smaller radius and slightly smaller length. Accordingly, the bottom layer must decrease in width slightly if the edges of the two layers are to remain aligned. In the illustrated embodiment, both edges of the top and bottom layer are laminated together with laminating adhesive 24 in the exposure area of the cap shingle. Accordingly, these edges are fixed relative to one another and cannot become misaligned as the multi-layer cap shingle is bent around the arc.

To absorb the decrease in width, i.e. the deformation, of the bottom layer 23, the slots 27 and 28 narrow progressively as the multi-layer cap shingle 21 is bent. This is indicated by arrows 29 and 31 in FIG. 6. As a result, the multi-layer cap shingle can be bent easily around the arc since the bottom layer becomes slightly narrower during the process and does not resist the bending. In other words, the slots 27 and 28 that comprise the deformation-absorbing mechanism absorb the reduction in width of the bottom layer by narrowing as the multi-layer cap shingle 21 is bent. As a result, the edges of the top and bottom layers remain aligned with each other regardless of the radius of the arc. This presents a more aesthetically pleasing cap shingle installation than traditional prior art multi-layer cap shingles wherein one edge of the top layer 22 becomes misaligned with the corresponding edge of the bottom layer 23 as described above.

An additional significant advantage of the multi-layer cap shingle of this disclosure arises from the fact that the bottom and top layers 22 and 23 are laminated together with laminating adhesive 24 adjacent both side edges at least in the exposure area of the cap shingle. As a result, the multi-layer cap shingle is highly resistant to wind lift along both of its edges. This, in conjunction with the sealing of the shingle to an underlying shingle by means of sealant patches 26, makes an installation of multi-layer cap shingles very stable and wind resistant.

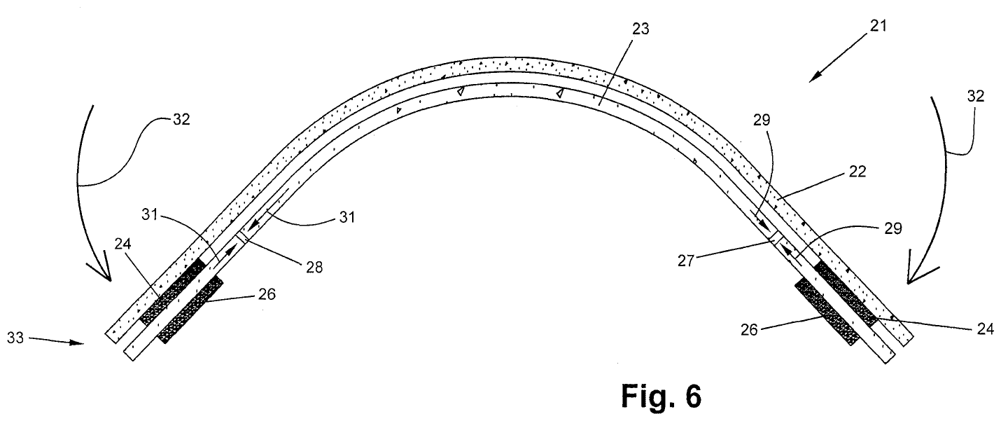

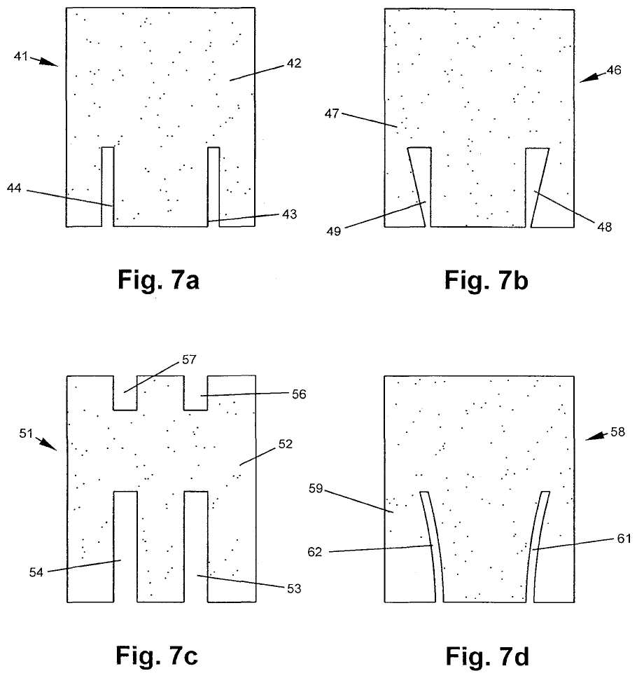

FIGS. 7a-7d show in plan views other examples of how the deformation-absorbing mechanism in a lower layer of a multi-layer cap shingle may be implemented. These examples are not intended to be exhaustive or limiting. Any feature in the bottom layer of the multi-layer cap shingle that permits the bottom layer to narrow in width should be construed to be within the scope of the present disclosure. FIG. 7a shows a bottom layer of shingle material 41 having a surface 42. In this example, two parallel slots 43 and 44 extend from the forward edge of the bottom layer rearwardly within the exposure area of the layer. As discussed above, these slots 43 and 44 narrow when a multi-layer cap shingle incorporating the bottom layer 41 is bent around an arc to absorb the deformation or narrowing of the bottom layer relative to the top layer.

Similarly, FIG. 7b illustrates a deformation-absorbing mechanism in the form of two generally trapezoidal cutouts 48 and 49 that widen from the forward edge of the bottom layer 46 in the exposure area. This configuration can improve the deformation-absorbing capability and/or improve the flexibility of the multi-layer cap shingle without exposing large gaps along the forward edge of the shingle. FIG. 7c shows an example of a bottom layer 51 of shingle material wherein the deformation-absorbing mechanism comprises a pair of slots 53 and 54 in the exposure area of the layer and a pair of slots 56 and 57 in the headlap area of the layer. The addition of slots 56 and 57 in the headlap area makes the resulting multi-layer cap shingle lighter and more easily bent. The slots 53 and 54 in the exposure area increases flexibility and allows the bottom layer 51 to narrow in width as the multi-layer cap shingle is bent around an arc.

FIG. 7d illustrates another embodiment of the deformation-absorbing mechanism in the form of two curved slots 61 and 62 formed in the bottom layer 58 within the exposure area. The curve of the slots is predetermined to follow the amount of deformation experienced by the bottom layer as the multi-layer cap shingle is bent over the ridge of a roof. The bending deformation increases from the center of rotation (the roof ridge point) to the far edge of the multi-layer cap shingle as the shingle is applied. Further, since the shingles are installed in piggyback fashion, the arc of curvature at the front edge of the shingle is somewhat larger than the arc of curvature at the back edge of the shingle. The curved configuration of the deformation-absorbing mechanism shown in FIG. 7d takes these factors into account such that the bending deformation in the bottom layer is completely absorbed without creating stress points in the bottom layer.

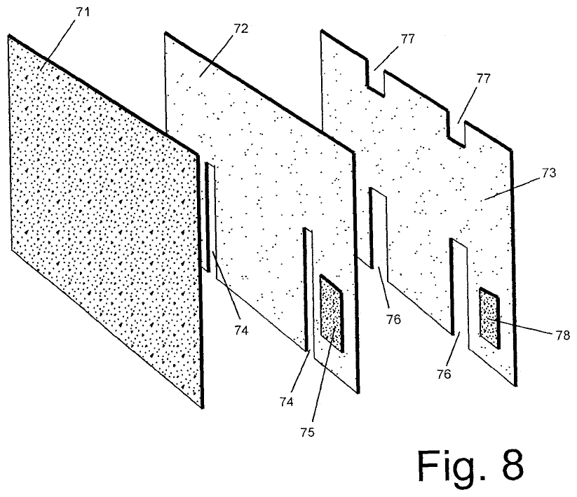

FIG. 8 illustrates a multi-layer cap shingle comprising three layers of shingle material; a top layer 71, a middle layer 72, and a bottom layer 73. The middle layer 72 incorporates the deformation-absorbing mechanism of FIG. 7a comprising spaced slots 74. The bottom layer 73 incorporates the deformation-absorbing mechanism of FIG. 7c comprising slots 76 in the exposure area and slots 77 in the headlap area. The bottom layer 73 is laminated to the middle layer in the exposure area by laminating adhesive 78 and the middle layer 72 is laminated to the top layer by laminating adhesive 75. When this three-layer cap shingle is bent around an arc, the middle layer and the bottom layer narrow in width as necessary to absorb the resulting relative deformations. The bottom layer narrows more than the middle layer because each must extend around an arc of a different radius and length.

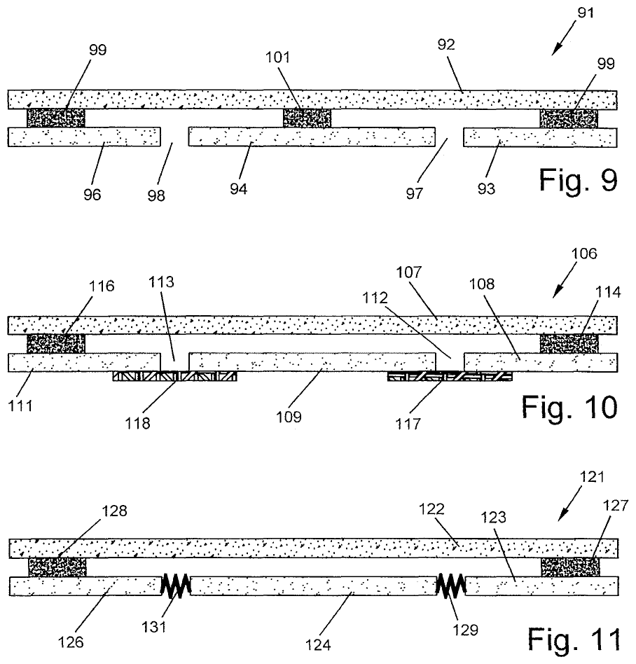

FIGS. 9-11 illustrate further embodiments of a multi-layer cap shingle exemplifying the present disclosure. FIG. 9 shows a multi-layer cap shingle 91 comprising a top layer 92 of shingle material laminated to a discontinuous bottom layer of shingle material. The discontinuities are defined by slots that extend completely from the front edge of the bottom layer to the back edge of the bottom layer. The bottom layer thus comprises a first outer edge portion 93, a central portion 94, and a second outer edge portion 96. Discontinuities 97 and 98 extend along the entire length of the bottom layer from its forward edge to its rear edge thus separating the three portions. The first edge portion 93 is laminated to the top layer 92 via laminating adhesive 99; the central portion 94 is laminated to the top layer 92 via laminating adhesive 101; and the second edge portion 96 is laminated to the top layer 92 via laminating adhesive 99. When the multi-layer cap shingle of this embodiment is bent around an arc for installation, the discontinuities narrow along the entire length of the bottom layer from front to back. Further, changing arc radius and length from the front to the back of the shingle in a piggyback installation is fully compensated. This makes the multi-layer cap shingle very flexible and adaptable and maintains the edges of the bottom layer aligned with the edges of the top layer.

FIG. 10 illustrates yet another embodiment of the present disclosure. As in the embodiment of FIG. 9, FIG. 10 illustrates a multi-layer cap shingle 106 having a top layer of shingle material 107 and a bottom layer of shingle material comprising a first edge portion 108, a central portion 109, and a second edge portion 111 separated by discontinuities 112 and 113. The first and second edge portions 108 and 111 are laminated to the top layer 107 by means of laminating adhesive 114 and 116 respectively. Unlike the embodiment of FIG. 9, the central portion 109 is not laminated to the top layer 107. Instead, it is attached to the first and second edge portions by strips of flexible material 117 and 118 that span the discontinuities and are bonded to the lower layer. The strips 117 and 118 may be made of any suitably flexible material such as a woven or non-woven fabric, a polymer, rubber, or other material. When the multi-layer cap shingle 106 of FIG. 10 is bent around an arc, the flexible strips 117 and 118 flex and deform as necessary to allow the discontinuities to narrow and absorb the narrowing deformation of the bottom layer relative to the top layer.

FIG. 11 illustrates an alternate embodiment of a multi-layer cap shingle 121 that is similar to the embodiment of FIG. 10 in that it has a top layer 122 and a bottom layer made up of first and second edge portions 123 and 126 and a central portion 124. In this embodiment, strips of accordion-folded material 129 and 131 span the discontinuities and attach the central portion 124 to the edge portions 123 and 126. When the multi-layer cap shingle of this embodiment is bent around an arc, the accordion folded strips 129 and 131 compress as necessary to allow the discontinuities to narrow and skew as necessary to absorb the deformation of the bottom layer.

The disclosure has been described herein in terms of various embodiments and configurations that represent examples of configurations that the disclosure might take and that represent the best modes of carrying out the disclosure. It will be understood, however, that a wide range of additions, deletions, and modifications, both subtle and gross, might well be made to the illustrated embodiments and further that entirely different embodiments may be conceived, all without departing from the spirit and scope of this disclosure, which is delineated only by the claims.

1. (canceled)

2. A roof, comprising:
a ridge, hip or cap;
a plurality of cap shingles configured to be installed over the ridge, hip, or cap of the roof;
wherein each of the cap shingles comprises:
a plurality of layers, including:
a top layer having opposite side edges, an exposure area, and a headlap area;
wherein the top layer is configured to bend in an arc having a first radius for installation of the cap shingle, along a ridge, hip, or rake of a roof; and
a bottom layer having opposite side edges substantially aligned with the opposite side edges of the top layer; and
an adhesive applied between a lower surface of the top layer and an upper surface of the bottom layer so as to bottom layer and the top layer together; and
wherein the bottom layer is configured to bend in an arc having a second radius that is different from the first radius, and with the first and second edges of the bottom layer remaining in a substantially fixed alignment with respect to the first and second edges of the top layer during installation of the cap shingle, along the ridge, hip, or rake of the roof.

3. The roof of claim 2, wherein the adhesive comprises a plurality of patches of adhesive applied between the aligned first and second side edges of the top and bottom layers.

4. The roof of claim 2, further comprising a sealant applied to a lower surface of the bottom layer opposite the exposure area of the top layer of each cap shingle, the sealant configured to seal each cap shingle to an adjacent cap shingle installed along the ridge, hip, or rake of the roof.

5. The roof of claim 4, wherein the sealant applied to the lower surface of the bottom layer comprises one or more sealant patches positioned adjacent to each of the first and second side edges of the bottom layer.

6. The roof of claim 2, further comprising at least one deformation-absorbing mechanism positioned along the bottom layer of each cap shingle; wherein the at least one deformation-absorbing mechanism is configured to facilitate bending of the bottom layer with the bending of the top layer during installation of each cap shingle along the ridge, hip, or rake of the roof.

7. The roof of claim 6, wherein the at least one deformation-absorbing mechanism comprises one or more slots, cutouts, a flexible material, folded material, or combinations thereof.

8. A cap shingle, comprising:
a plurality of layers, including:
a top layer of shingle material having a front edge, a back edge, first and second side edges, a lower surface, and an upper surface having an exposure area and a headlap area;
wherein the top layer is configured to bend in an arc having a first radius for installation of the cap shingle, along a ridge, hip, or rake of a roof; and
a bottom layer of shingle material having a lower surface, an upper surface, a front edge, a back edge, a first side edge substantially aligned with the first side edge of the top layer, and a second side edge substantially aligned with the second side edge of the top layer;
an adhesive applied between the lower surface of the top layer and the upper surface of the bottom layer;
wherein the adhesive is applied adjacent to the aligned first and second side edges of the top layer and bottom layers so as to attach the first and second side edges of the bottom layer to the first and second side edges of the top layer; and
a sealant applied to the lower surface of the bottom layer for sealing the cap shingle to an adjacent cap shingle installed along the ridge, hip, or rake of the roof; and
wherein the bottom layer is configured to bend in an arc having a second radius that is different from the first radius with the first and second edges of the bottom layer remaining in a substantially fixed alignment with respect to the first and second edges of the top layer during installation of the cap shingle, along the ridge, hip, or rake of the roof.

9. The cap shingle of claim 8, further comprising at least one slot formed in the bottom layer; wherein the at least one slot is configured to facilitate bending of the bottom layer with the bending of the top layer during installation of the cap shingle along the ridge, hip, or rake of the roof.

10. The cap shingle of claim 8, further comprising at least one deformation-absorbing mechanism formed in the bottom layer and extending at least partially along the bottom layer from the front edge of the bottom layer toward the back edge of the bottom layer; wherein the at least one deformation-absorbing mechanism is configured to facilitate bending of the bottom layer with the bending of the top layer during installation of the cap shingle along the ridge, hip, or rake of the roof.

11. The cap shingle of claim 10, wherein the at least one deformation-absorbing mechanism comprises one or more slots or cutouts formed in the bottom layer between the first and second side edges.

12. The cap shingle of claim 10, wherein the at least one deformation-absorbing mechanism comprises a flexible material, a foldable material, or a combination thereof.

13. The cap shingle of claim 8, wherein the sealant applied to the lower surface of the bottom layer comprises one or more sealant patches positioned opposite the exposure area of the top layer and extending at least partially along each of the first and second side edges of the bottom layer.

14. The cap shingle of claim 8, wherein the adhesive applied between the aligned first and second side edges of the top and bottom layers comprises a plurality of patches of adhesive; and wherein the sealant applied to the lower surface of the bottom layer comprises one or more sealant patches applied along the bottom layer opposite the exposure area of the top layer and configured to adhere the bottom layer to a headlap area of the adjacent cap shingle.

15. The cap shingle of claim 8, wherein the plurality of layers further comprises a middle layer of shingle material arranged between the top layer and the bottom layer, the middle layer having first and second side edges; and wherein the adhesive further comprise a plurality of adhesive patches positioned along the first and second side edges of the bottom, middle, and top layers so as to adhere the bottom, middle and top layers together.

16. A roof, comprising:
a ridge, hip or rake; and
a plurality of cap shingles configured to bend over the ridge, hip, or rake of the roof;
wherein each of the cap shingles comprises:
a top layer of shingle material having a front edge, a back edge, first and second side edges, a lower surface, and a top surface having an exposure area and a headlap area;
wherein the top layer is configured to bend in an arc having a first radius for installation of the cap shingle, along a ridge, hip, or rake of a roof, and
a bottom layer of shingle material having a lower surface, a top surface, a front edge, a back edge, a first side edge substantially aligned with the first side edge of the top layer, a second side edge substantially aligned with the second side edge of the top layer;
an adhesive applied between the aligned first and second side edges of the top and bottom layers so as to attach the first and second side edges of the bottom layer to the first and second side edges of the top layer; and
wherein the bottom layer is configured to bend in an arc having a second radius that is different from the first radius, such that the first and second edges of the bottom layer remain in a substantially fixed alignment with respect to the first and second edges of the top layer during installation of the cap shingle, along the ridge, hip, or rake of the roof.

17. The roof of claim 16, further comprising at least one deformation-absorbing mechanism extending at least partially along the bottom layer from the front edge of the bottom layer toward the back edge of the bottom layer of each cap shingle; wherein the at least one deformation-absorbing mechanism is configured to facilitate bending of the bottom layer with the top layer during installation of each cap shingle along the ridge, hip, or rake of the roof.

18. The roof of claim 17, wherein the at least one deformation-absorbing mechanism comprises one or more slots or cutouts formed in the bottom layer between the first and second side edges thereof.

19. The roof of claim 16, wherein the adhesive comprises a plurality of spaced apart adhesive patches applied between the top and bottom layers.

20. The roof of claim 16, further comprising a plurality of patches of a sealant applied to the lower surface of the bottom layer opposite the exposure area of the top layer of the cap shingle and configured to adhere the bottom layer of the cap shingle to a headlap area of an adjacent cap shingle.

21. The roof of claim 16, wherein the adhesive applied between the aligned first and second side edges of the top and bottom layers comprises a plurality of patches of adhesive, and wherein at least two patches of adhesive are applied between the top and bottom layers adjacent to the aligned first and second side edges thereof; and further comprising at least one patch of a sealant is applied along a lower surface of the bottom layer of opposite the exposure area of the top layer and is configured to adhere the bottom layer of the cap shingle to a headlap area of an adjacent cap shingle.
